(19) United States
(12) Patent Application Publication
(10) Pub. No.: US 2017/0059139 A1
(43) Pub. Date: Mar. 2, 2017

(54) LED LUMINAIRE

(71) Applicant: ABL IP Holding LLC, Decatur, GA (US)

(72) Inventor: Forrest Starnes McCanless, Oxford, GA (US)

(21) Appl. No.: 15/247,224

(22) Filed: Aug. 25, 2016

Related U.S. Application Data
(60) Provisional application No. 62/210,004, filed on Aug. 26, 2015.

(51) Int. Cl. F21V 17/16; F21K 9/278; F21V 3/02; F21V 7/00; F21V 23/00; F21K 9/272; F21V 15/015

(52) U.S. Cl. CPC F21V 17/164; F21K 9/272; F21K 9/278; F21V 15/015; F21V 7/00; F21V 23/005; F21V 3/02; F21Y 2115/10

(57) ABSTRACT

An LED luminaire includes a reflector, a channel, and a printed circuit board (PCB) onto which LEDs are mounted. Each of the reflector, the channel, and the PCB includes a feature(s) that permit their attachment to each other without the need for separate fasteners and tools. Embodiments of the LED luminaire may also include an optic and a pair of end caps, also designed for assembly into the LED luminaire without the use of or need for separate fasteners and tools.

### REFERENCE TO RELATED APPLICATIONS

This application claims the benefit of U.S. Provisional Application Ser. No. 62/210,004, filed on Aug. 26, 2015, and entitled LED LUMINAIRE ASSEMBLY, the content of which is hereby incorporated in its entirety by this reference.

### FIELD OF THE INVENTION

Embodiments of the present invention provide means by which to assemble various components of a light emitting diode (LED) luminaire whereby the components engage each other without the need for separate mechanical fasteners.

### BACKGROUND

Assembling luminaires, such as an LED luminaire, typically requires an assembler to perform a multitude of operations with a number of various tools and fasteners. In various situations, such as during high volume fabrication of lighting assemblies, the time (and thus associated cost) required to assemble the luminaires is increased because of the number of tools and fasteners needed. Therefore, there is a need for a lighting assembly that is easy to assemble in various situations including, but not limited to, high volume fabrication manufacturing.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments of the present invention, an LED luminaire includes a reflector, a channel, and a printed circuit board (PCB) onto which LEDs are mounted. Each of the reflector, the channel, and the PCB includes a feature(s) that permit their attachment to each other without the need for separate fasteners and tools. Embodiments of the LED luminaire may also include an optic and a pair of end caps, also designed for assembly into the LED luminaire without the use of or need for separate fasteners and tools.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a partially exploded perspective view of a LED luminaire according to an embodiment of the present invention, the LED luminaire of FIG. 1 including a reflector, channel, LED boards and an optic.

FIG. 2 is a perspective view of the reflector of the LED luminaire of FIG. 1.

FIG. 3 is a detail view of reflector clips of the reflector of FIG. 2.

FIG. 4 is a detail view of arms of a reflector according to an embodiment of the present invention.

FIG. 5 is a perspective view of one of the channels of the LED luminaire of FIG. 1.

FIG. 6 is a detail view of an end tab of the channel of FIG. 5.

FIG. 7 is a detail view of side channel tabs of the channel of FIG. 5.

FIG. 8 is a detail view of central tabs of the channel of FIG. 5.

FIG. 9 is a perspective view of a PCB of the LED luminaire of FIG. 1.

FIG. 10 is a partial perspective view of the LED board of FIG. 9 retained on the channel of FIG. 5, which is retained on the reflector of FIG. 2.

FIG. 11 is another partial perspective view of the LED board of FIG. 9 retained on the channel of FIG. 5, which is retained on the reflector of FIG. 2.

FIG. 12 is yet another partial perspective view of the LED board, the channel and the reflector of FIG. 10.

FIG. 13 is a partial perspective view of an embodiment of an end cap positioned on the reflector of FIG. 2.

FIG. 14 is another partial perspective view of the embodiment of the end cap positioned on the reflector of FIG. 2.

FIG. 15 a partial perspective view of an embodiment of an optic retained on the channel of FIG. 5.

FIG. 16 is a partial perspective view of the optic of FIG. 15 engaging the end cap of FIG. 13.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

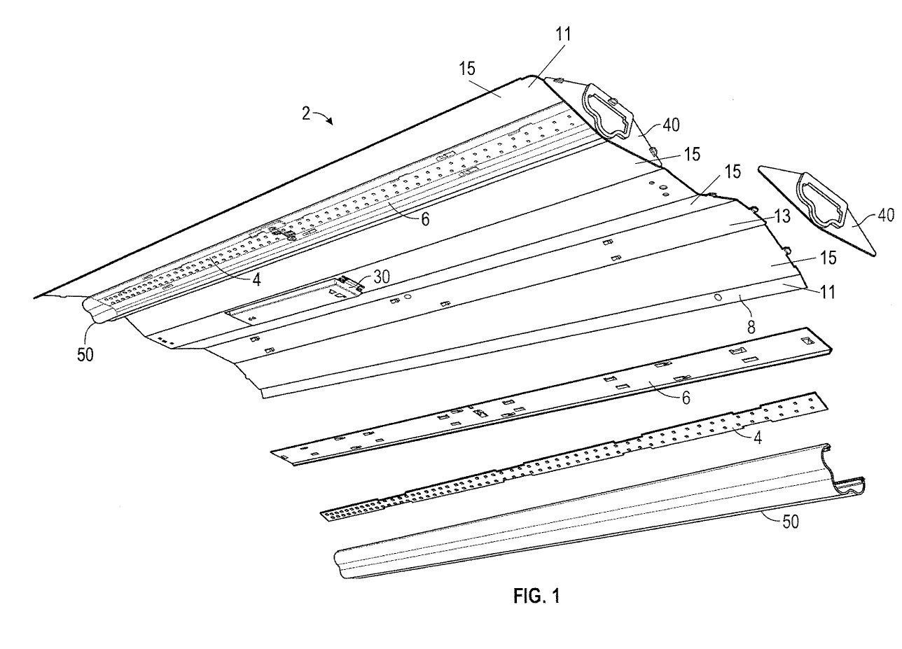

Referring to FIG. 1, in one embodiment, a LED luminaire 2 includes one or more printed circuit boards (PCB) 4 with LEDs 3 retained on one or more channels 6, which in turn is retained on a reflector 8. In various examples, one or more end caps 40 may be positioned on each of the ends of the reflector 8 (end caps 40 are only shown on one end of the reflector in FIG. 1). An optic 50 may be positioned over the LEDs 3 to enclose the LEDs 3 within the LED luminaire 2.

The Reflector

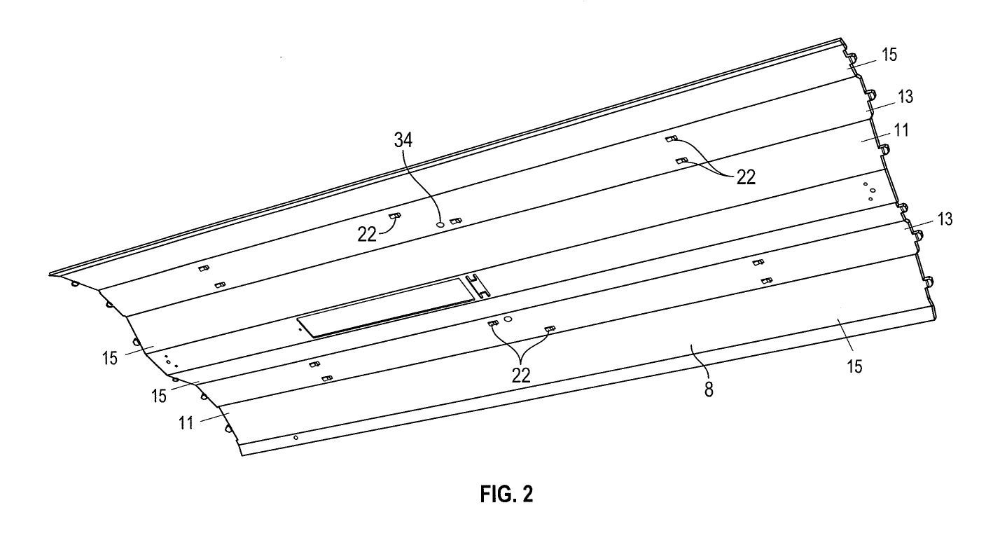

Details of the reflector of FIG. 1 are shown in FIGS. 2-4. The reflector may be formed to have any shape or dimension. For example and without limitation, while the illustrated reflector 8 is shown having two troughs 11 (each provided with an associated channel 6, LEDs 3, end caps 40, etc.), the reflector 8 could have only a single trough or more than two troughs.

Each trough 11 includes a channel-receiving portion 13 from which sidewalls 15 downwardly extend. The reflector may be formed integrally or, alternatively, the various reflector components may be formed separately and assembled together to form the reflector. The reflector may be formed of any suitable material, including metallic and polymeric materials. The surface of the sidewalls 15 preferably has an extremely high surface reflectivity, preferably, but not necessarily, between 96%-99.5%, inclusive and more preferably 98.5-99%. To achieve the desired reflectivity, in one embodiment the reflective surface comprises polished metals such as, but not limited to, polished aluminum. In other embodiments, reflective coatings, including reflective paints or other reflective compositions, are applied to the reflector to attain the desired reflectivity.

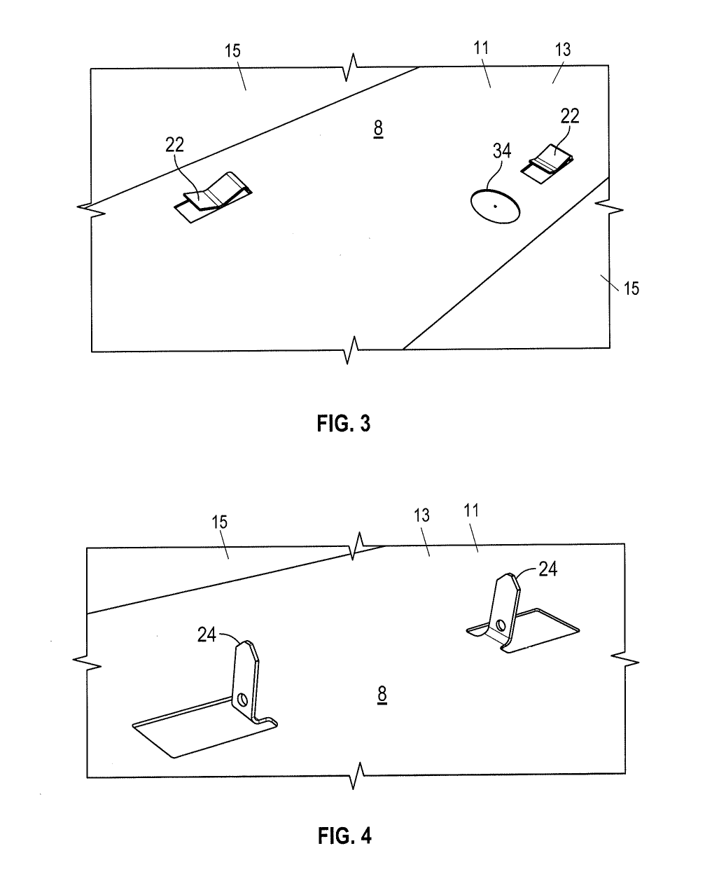

Referring to FIGS. 2 and 3, in some examples, the reflector 8 includes reflector clips 22 that engage the channel 6 to retain the channel 6 on the reflector 8, as described in detail below. In other embodiments, as illustrated in FIG. 4, the reflector 8 includes reflector arms 24, which may be bent to secure the PCB 4, channel 6, and reflector 8 together, as described in more detail below. In various other embodiments, various combinations, positions, and orientations of reflector clips 22 and reflector arms 24 may be utilized. In some examples, a wireway 34 is provided in the reflector 8 for permitting wires 32 to pass therethrough and reach the PCBs 4.

The Channel(s)

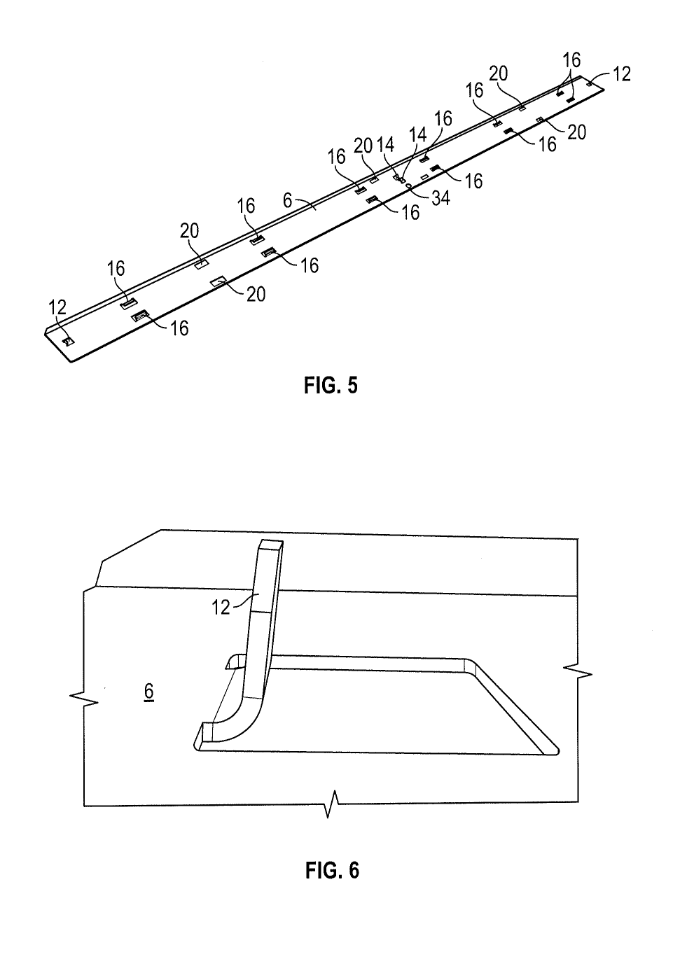

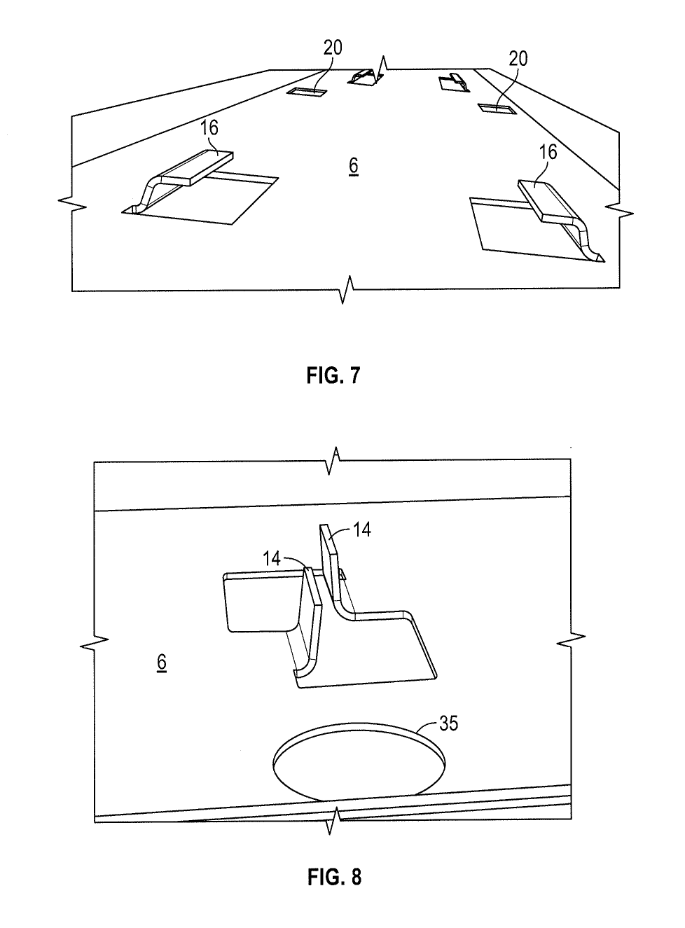

At least one channel 6 is provided in each reflector trough 11. As illustrated in FIGS. 5-8, the channel 6 includes a number of tabs and apertures, which may be used to retain the PCB 4 on the channel 6 and the channel 6 on the reflector 8, as described in more detail below. An upstanding end tab 12 (see FIG. 6) is provided on each end of the channel 6. Side channel tabs 16 (see FIG. 7) are provided at locations along the length of the channel 6 to capture edges of the PCBs 4.

In some examples, as illustrated in FIG. 8, the channel 6 is shown configured to accommodate two PCBs 4 positioned in series, and includes a set of upstanding central tabs 14 provided more centrally on the channel 6. However, one of skill will understand that the channel 6 could accommodate a single PCB 4 (in which case the pair of central tabs 14 would be unnecessary) or more than two PCBs 4 (in which case more than one pair of central tabs 14 could be used).

Moreover, while three pairs of side channel tabs 16 are shown in FIG. 5 for supporting each PCB 4, the number of side channel tabs 16 should not be considered limiting on the current disclosure as additional or fewer side channel tabs 16 may be provided. In some examples, the side channel tabs 16 may be provided directly across from each other on the channel 6. In other examples, the side channel tabs 16 of the channel 6 need not be oriented directly across from each other, but rather could be staggered.

Clip apertures 20 are also formed in the channel 6 to facilitate attachment to the reflector, as described below. In some examples, a wireway 35 is also provided in the channel 6. The wireway 35 may be aligned with the wireway 34 of the reflector 8 for permitting wires 32 to pass therethrough and reach the PCBs 4.

The PCBs

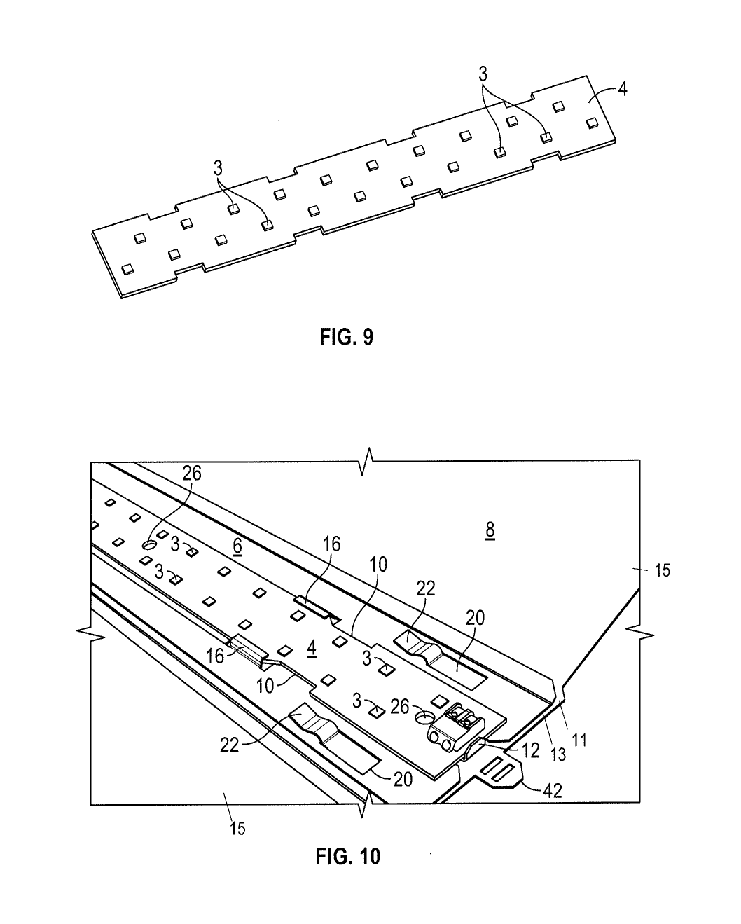

Referring to FIG. 9, each PCB 4 may be populated with any number of LEDs 3 oriented in any way on the PCB 4. The LEDs may be single-die or multi-die LEDs, DC or AC, or can be organic light emitting diodes. White, color, or multicolor LEDs may be used. Moreover, the LEDs need not all be the same color; rather, mixtures of LEDs may be used. The PCB 4 can be, among other things, metal core board, FR4 board, CHM1 board, etc. In some embodiments, the PCB 4 is a substantially rigid board that elastically deforms. In other words, when flexed below its yield point, PCB 4 attempts to recover and return to its naturally flat state (as opposed to plastic deformation where the board would be permanently deformed with no ability to return to its original shape). The “springiness” of the PCB 4 can facilitate installation, as described below.

Pairs of notches 10 are provided along the side edges of the PCB 4 along the length of the PCB 4. While not required, the number of pairs of notches 10 on the PCB 4 may be the same as the number of pairs of side channel tabs 16 provided on channel 6. In some examples, the notches 10 on the PCB 4 are oriented directly across from each other, although they need not be. For example and without limitation, in other examples, the notches 10 could be staggered to accommodate staggered side channel tabs 16 during installation of the PCB 4 onto the channel 6. While rectangular notches 10 are illustrated in some figures, in other embodiments at least one notch edge is beveled, rounded, or have any other shape such that the notches 10 are not rectangular. For example, in some embodiments, providing notches 10 having beveled leading edges may help with sliding of the PCB 4 under the side channel tabs 16, as described in detail below. These beveled edges may also serve as a visual clue to the proper orientation of the PCB 4 relative to the channel 6.

In some embodiments, a driver (not shown) for powering the LEDs 3 is located above the reflector 8. It some non-limiting embodiments, the driver might be mounted to an upper surface of the reflector 8. A door 30 may optionally be provided in the reflector 8 for accessing, servicing, and/or replacing the driver.

The Optic(s)

An optional optic 50 may be positioned over the LEDs of each reflector trough 11. The optic 50 may be of any type (diffuse, prismatic, etc.) that achieves the desired light emission from the LED luminaire 2. The optic 50 may have any geometry, and may be provided with any surface enhancements or with no surface enhancements. By way only of example, the optic 50 could have the shape of the optics disclosed in U.S. patent application Ser. No. 14/696,042, filed on Apr. 24, 2015 and entitled “Tri-Lobe Optic and Associated Light Fixtures,” the entirety of which is herein incorporated by reference.

Assembly of the LED Luminaire 2

Referring to FIGS. 9, 10, and 12, to secure the PCB 4 to the channel 6, the PCB 4 is positioned relative to the channel 6 such that the pairs of notches 10 on the PCB 4 align with the pairs of side channel tabs 16 on the channel 6. The notches 10 and side channel tabs 16 are shaped such that the PCB 4 may be moved downwardly onto the channel 6 and the notches 10 pass over and clear the side channel tabs 16 during positioning of the PCB 4. As disclosed above, the pairs of notches 10 need not be laterally aligned but rather may be staggered relative to each other. Similarly, the pairs side channel tabs 16 need not be laterally aligned but rather may be staggered relative to each other. However, the pairs of notches 10 and side channel tabs 16 should be provided such that the notches 10 can align with the side channel tabs 16 to permit clearance of the PCB 4 over the side channel tabs 16 and positioning of the PCB 4 on the channel 6.

During this step, an end of the PCB 4 may rest on the top of the end tab 12 of the channel 6. After aligning the notches 10 of the PCB 4 with the side channel tabs 16 on the channel 6, the PCB 4 may be slid inwardly along the length of the channel 6 such that the side edges of the PCB 4 are trapped beneath the side channel tabs 16 of the channel 6 and the ends of the PCB 4 abut the end tab 12 and central tab 14 of the channel 6. In some examples, sliding the PCB 4 that is initially resting on the top of the end tab 12 includes flexing the PCB 4 such that the PCB 4 can be slid with the side edges of the PCB 4 trapped beneath the side channel tabs 16 and the ends of the PCB 4 abut the end tab 12 and central tab 14. In other embodiments, the notches 10 may be provided on the PCB 4 such that alignment of the notches 10 with the side channel tabs 16 results in an end of the PCB 4 resting on top of a central tab 14. The PCB 4 is then slid in the opposite direction—outwardly along the length of the channel 6—to trap the side edges of the PCB 4 under the side channel tabs 16. In these examples, the PCB 4 is retained on the channel 6 both laterally (by the side channel tabs 16) and longitudinally (by the end tabs 12 and optionally the central tabs 14). One of skill in the art will readily understand that, if a single PCB is used, its ends will abut the end tabs 12 on each end of the channel 6 when installed.

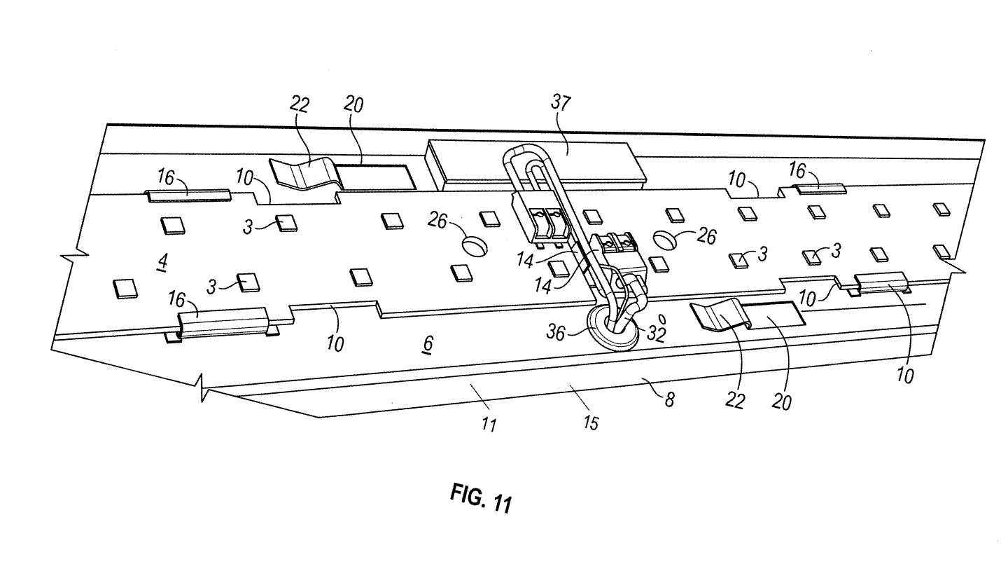

To secure the channel 6 on the reflector 8, the channel 6 is positioned over the reflector 8 so that the reflector clips 22 align with the clip apertures 20 in the channel 6, and the channel 6 may be seated on the reflector 8. Once seated, the channel 6 may be slid relative to the reflector 8 such that the reflector clips 22 engage or clip onto the channel 6 to retain the channel 6 on the reflector 8 (see FIGS. 9 and 10). In the illustrated embodiment, some of the reflector clips 22 are optionally offset from each other along the length of the reflector 8, and the corresponding clip apertures 20 are offset from each other along the length of the channel 6 but positioned so as to align with the reflector clips 22 for engagement as discussed above. Such offset may be desirable, but certainly not required, to ensure that the channel 6 is oriented properly relative to the reflector 8 for wireway alignment, as discussed below. It will be understood that, in this assembly embodiment, the PCB 4 may be secured to the channel 6 before or after the channel 6 is secured to the reflector 8.

In an alternative assembly embodiment, the notches 10, side channel tabs 16, and reflector clips 22 are not needed. Rather, as illustrated in FIG. 11, the PCB 4, channel 6, and reflector 8 are secured together by the reflector arms 24 extending from the reflector 8 and engaging slots or other shaped apertures 26 in the channel 6 and PCB 4. In some examples, when assembling the PCB 4, channel 6, and reflector 8 in FIG. 11, the channel 6 and PCB 4 are stacked onto the reflector 8 via insertion of the reflector arms 24 into the slots or other shaped apertures 26 on the channel 6 and PCB 4. The reflector arms 24 may be bent to secure the PCB 4, channel 6, and reflector 8 together. Optionally, the reflector arms 24 secure the PCB 4 against the end tabs 12, the central tabs 14, or both.

As previously described, in some embodiments where the driver is positioned above the reflector 8, incoming wires 32 may need to pass through the reflector 8 and channel 6 to reach the PCBs 4. It may be desirable to locate those wires 32 centrally (i.e., center feed the PCB 4) to keep the wires 32 shorter, although such a feature is not required. In the illustrated embodiments, the wires 32 may pass through the aligned wireways 34 and 35 of the reflector 8 and channel 6, respectively, and reach the PCBs 4. A grommet 36 may be located in the wireways 34 and 35 to help further secure the reflector 8 and channel 6 together, as well as create a seal that prevents the ingress of bugs and other debris into the LED luminaire 2.

The wires 32 may be electrically connected to the PCBs 4. In some examples, the space between adjacent central tabs 14 forms a path for the wires 32 that retains the wires 32 in position and prevents them from migrating in front of the LED 3 and creating shadows. In some examples, as illustrated in FIG. 11, device 37, which may be a radio frequency (RF) antenna, infra-red (IR) sensor, various other antennas, various other sensors, various other devices, or various combinations of devices, may be mounted on the channel 6 adjacent to the PCB 4 or directly on the PCB 4 itself. In some examples, the device 37 is mounted through adhesives, although various other suitable mounting mechanisms may be utilized.

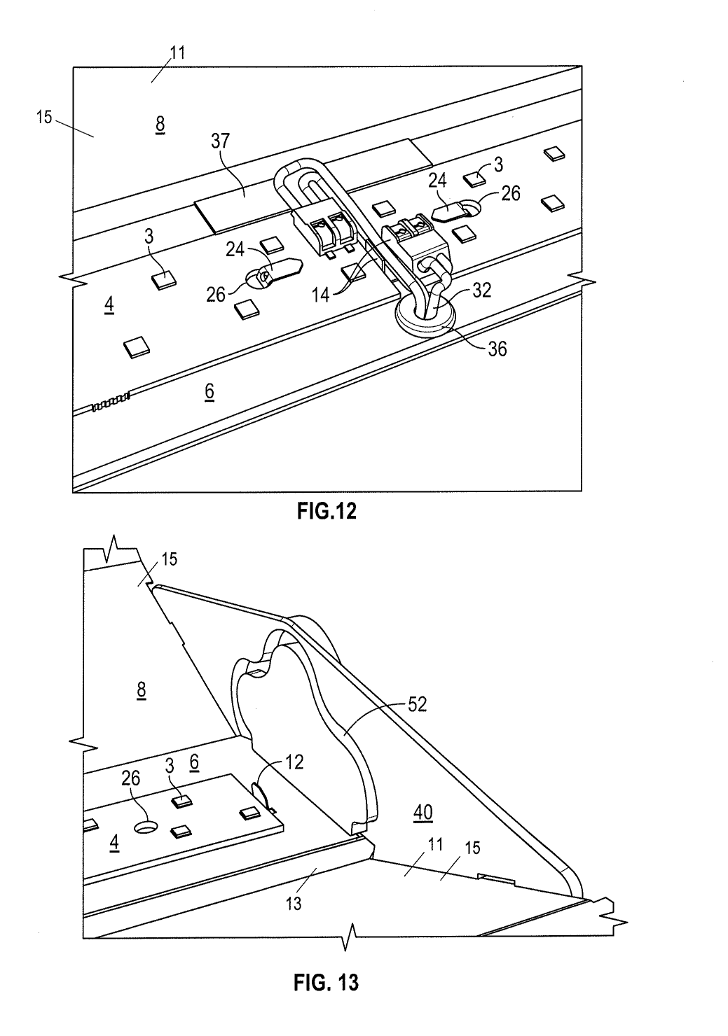

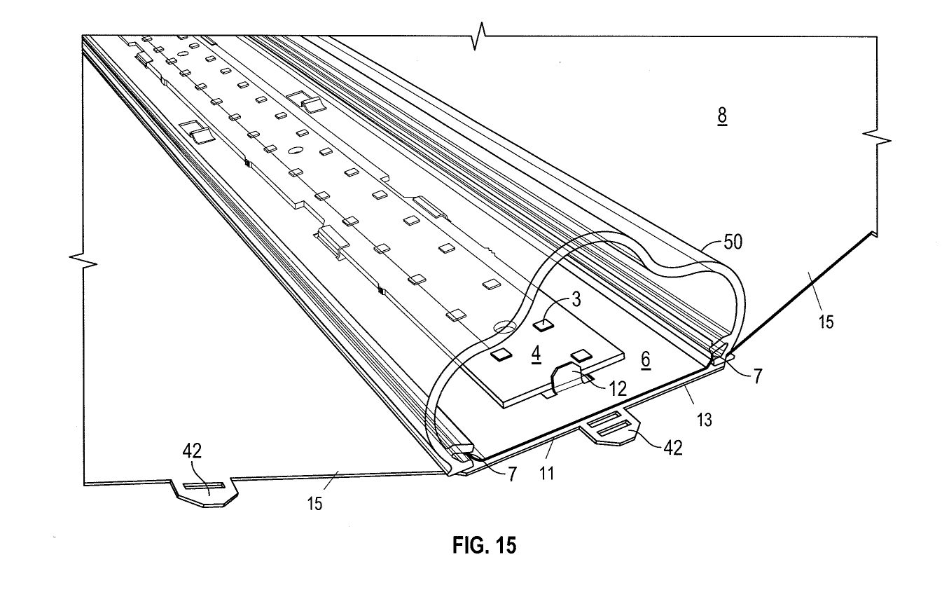

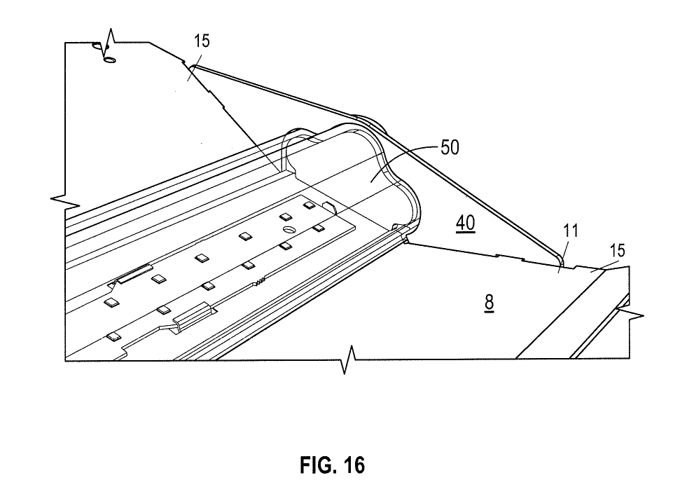

Referring to FIGS. 12-15, in some embodiments, the channel 6 includes angled side edges 7 onto which the optic 50 may be snap-fitted.

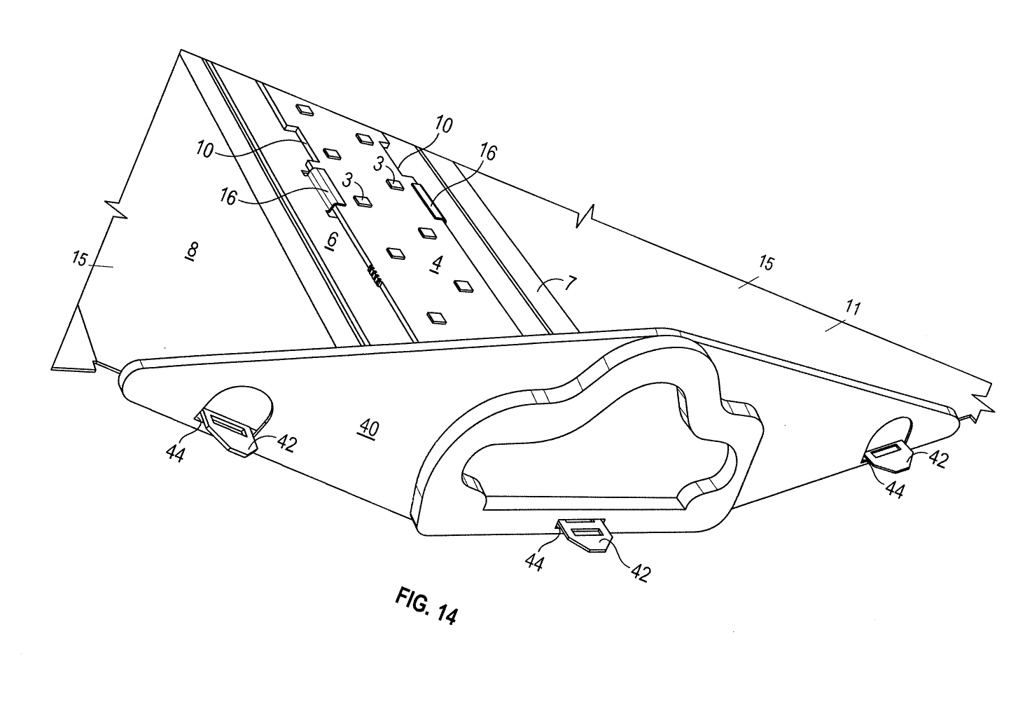

End caps 40 may be mounted on the ends of the reflector 8 to lock the channel 6 and optic 50 longitudinally in place within the LED luminaire 2 and/or to impart a polished appearance to the fixture. In some embodiments, the optic 50 is retained via tabs 42 extending from the ends of the reflector 8 engaging slots 44 in the end caps 40. See FIGS. 13 and 14. Once the tabs 42 are inserted into the slots 44, they are bent to hold the end caps 40 to the reflector 8. The tabs 42 and slots 44 should not be considered limiting on the current disclosure as various other attachment means and configurations are contemplated.

Grooves 52 having the same or similar profile as the optic 50 may be provided in the end caps 40. When the end caps 40 are mounted, the ends of the optic 50 may seat in the grooves 52 in the end caps 40 to help retain the optic 50 in place within the LED luminaire 2.

Engagement of the PCB 4, channel 6, and reflector 8 results in a complete sealing of any apertures between the components such that the PCB 4/channel 6/reflector 8 barrier is impermeable to bugs, insects and other debris that detrimentally impact operation and light emission of the LED luminaire 2. Engagement of the optic 50 with the channel 6 and positioning of the optic 50 ends within the end caps 40 further helps to seal the LED compartment.

The LED luminaire 2 can be used in new light fixtures or sold as a retrofit kit for use in existing light fixtures already installed in the field (e.g., installed to replace the fluorescent light sources in existing fixtures). The LED luminaire 2 may be used in any type of light fixture, including, but not limited to, recessed troffer, surface mounted, and suspended fixtures.

In some embodiments, the reflector 8 and channel 6 are formed from metallic materials, such as aluminum. In such embodiments, the retention features can be formed by stamping the desired patterns and apertures from the metal and shaping the metal to have the desired geometry.

The foregoing is provided for purposes of illustrating, explaining, and describing embodiments of the present invention. Further modifications and adaptations to these embodiments will be apparent to those skilled in the art and may be made without departing from the scope or spirit of the invention. Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the invention.

1. A luminaire comprising:
a reflector having two opposing ends and a channel-receiving portion, the channel-receiving portion extending between the two opposing ends and comprising reflector clips in the channel-receiving portion;
a channel comprising opposing side edges each having a length, the channel further comprising clip apertures and side channel tabs, wherein the side channel tabs extend a distance along the length of the opposing side edges of the channel and extend upwardly from the channel, the channel mounted on the reflector such that the reflector clips are engaged with the channel through the clip apertures;
a printed circuit board (PCB) mounted on the channel by positioning opposing side edges of the PCB under the side channel tabs; and
a plurality of light emitting diodes (LEDs) provided on the PCB.

2. The luminaire of claim 1, wherein the opposing side edges of the PCB each having a length and notches extending a distance along the length of the opposing side edges of the PCB, wherein the distance of one of the notches on the PCB is at least as great as the distance of one of the side channel tabs on the channel such that the notches on the PCB can receive the side channel tabs.

3. The luminaire of claim 2, wherein the PCB is a first PCB, wherein the luminaire further comprises a second PCB, wherein the channel further comprises center tabs and end tabs, the center tabs between the end tabs, wherein the first PCB is mounted on the channel between a one of the end tabs and a one of the center tabs, and wherein the second PCB is mounted on the channel between a second of the end tabs and a second of the center tabs.

4. The luminaire of claim 3, wherein the center tabs define a wire pathway between the center tabs, and wherein the wire pathway is dimensioned to accommodate at least one wire of the luminaire.

5. The luminaire of claim 1, further comprising an optic having opposing ends and opposing side edges that engage the opposing side edges of the channel.

6. The luminaire of claim 5, further comprising a pair of end caps, each one of the pair of end caps mounted to an opposing end of the reflector, wherein each end cap comprises an end cap groove and wherein a one opposing end of the optic engages the end cap groove in one of the pair of end caps.

7. The luminaire of claim 6, wherein the reflector further comprises end cap tabs extending from the opposing ends of the reflector, wherein each one of the pair of end caps comprises end cap slots, and wherein the pair of end caps mounted at the opposing ends of the reflector such that the end cap tabs extend through the end cap slots.

8. The luminaire of claim 5, wherein the opposing side edges of the channel are angled.

9. The luminaire of claim 1, wherein the clip apertures and side channel tabs of the channel are formed integrally with the channel.

10. The luminaire of claim 1, wherein the channel further comprises end tabs at opposing ends of the channel, and wherein the PCB is mounted on the channel between the end tabs.

11. The luminaire of claim 1, further in comprising at least one of a radio frequency (RF) antenna or an infra-red (IR) sensor mounted on the channel adjacent to the PCB.

12. A luminaire comprising:
a reflector having two opposing ends and a channel-receiving portion, the channel-receiving portion extending between the two opposing ends and comprising reflector arms in the channel-receiving portion;
a channel comprising opposing side edges each having a length, the channel further comprising channel apertures provided along the length of each of the opposing side edges of the channel and end tabs at opposing end edges of the channel, the channel mounted on the reflector such that the reflector arms are engaged with the channel through the channel apertures;
a printed circuit board (PCB) having PCB apertures, the PCB mounted on the channel such that the PCB is between the end tabs of the channel and the reflector arms extend through the PCB apertures; and
a plurality of light emitting diodes (LEDs) provided on the PCB.

13. The luminaire of claim 12, wherein the PCB is a first PCB, wherein the luminaire further comprises a second PCB, wherein the channel further comprises center tabs between the end tabs, wherein the first PCB is mounted on the channel between a one of the end tabs and a one of the center tabs, wherein the second PCB is mounted on the channel between a second of the end tabs and a second of the center tabs, and wherein the center tabs define a wire pathway between the center tabs, and wherein the wire pathway is dimensioned to accommodate at least one wire of the luminaire.

14. The luminaire of claim 12, wherein the reflector further comprises end cap tabs extending from opposing ends of the reflector, and wherein the luminaire further comprises:
a pair of end caps, each one of the pair of end caps having end cap slots, the pair of end caps mounted at the opposing ends of the reflector such that the end cap tabs extend through the end cap slots.

15. The luminaire of claim 14, wherein each one of the pair of end caps comprises an end cap groove, and wherein the luminaire further comprises an optic having opposing ends, wherein each end of the optic engages the end cap groove of one of the pair of end caps.

16. A method of assembling a luminaire comprising:
aligning clip apertures of a channel with reflector clips of a reflector in a channel-receiving portion of the reflector;
positioning the reflector clips within the clip apertures;
sliding the channel relative to the reflector such that the reflector clips engage the channel;
aligning notches extending along opposing edges of a printed circuit board (PCB) with side channel tabs provided along a length of the channel;
positioning the side channel tabs within the notches; and
sliding the PCB relative to the channel such that the side channel tabs engage the PCB.

17. The method of claim 16, wherein the channel further comprises end tabs at opposing ends of the channel, and wherein the method further comprises:
sliding the PCB relative to the channel such that the PCB is between the end tabs and abutting the end tabs.

18. The method of claim 17, wherein the PCB is a first PCB, wherein the luminaire further comprises a second PCB having notches extending along opposing ends of the second PCB, wherein the channel further comprises center tabs between the end tabs, wherein aligning the notches the first PCB with the side channel tabs of the channel comprises aligning the notches of the first PCB with side channel tabs between a one of the end tabs and a one of the center tabs, wherein sliding the first PCB comprises sliding the first PCB such that the first PCB is between the one of the end tabs and the one of the center tabs and abutting the one of the end tabs and the one of the center tabs; and wherein the method further comprises:
aligning the notches of the second PCB with side channel tabs between a second of the end tabs and a second of the center tabs;
positioning the side channel tabs between the second of the end tabs and the second of the center tabs within the notches of the second PCB; and
sliding the second PCB relative to the channel such that the side channel tabs between the second of the end tabs and the second of the center tabs engage the second PCB, the second PCB is between the second of the end tabs and the second of the center tabs, and the second PCB abuts the second of the end tabs and the second of the center tabs.

19. The method of claim 16, further comprising:
mounting a pair of end caps to the reflector at opposing ends of the reflector; and
retaining an optic between the pair of end caps and above the channel and the PCB.

20. The method of claim 19, wherein retaining the optic between the pair of end caps comprises positioning ends of the optic in end cap grooves defined by each one of the pair of end caps.

21. A light engine comprising:
a channel comprising a length and a plurality of channel tabs, each extending upwardly from the channel and along a distance of the length of the channel;
a printed circuit board (PCB) mounted on the channel by positioning at least portions of opposing side edges of the PCB under the plurality of channel tabs, the opposing side edges of the PCB each having a length and at least one notch extending a distance along the length of the opposing side edge, wherein the distance of the at least one notch on each opposing side of the PCB is at least as great as the distance of the channel tabs on the channel such that the at least one notch on each opposing side of the PCB can receive one of the channel tabs; and
a plurality of light emitting diodes (LEDs) provided on the PCB.
